(19) United States
(12) Patent Application Publication
(10) Pub. No.: US 2010/0006351 A1
(43) Pub. Date: Jan. 14, 2010

(54) Electric vehicle with contra-recgarge system

(76) Inventor: J. Scott Howard, White Hall, AR (US)

Correspondence Address: Stephen D. Carver;Suite 800, 2024 Arkansas Valley Drive, Little Rock, AR, 72212-4147, US

(21) Appl. No.: 12/380,548

(22) Filed: Mar. 2, 2009

Related U.S. Application Data
(60) Provisional application No. 61/134,127, filed on Jul. 8, 2008.

(51) Int. Cl. B60K 1/00; B60K 16/00

(52) U.S. Cl. 180/2.2; 180/65.31

(57) ABSTRACT

An electrically powered vehicle that is recharged and self-energized during travel by apparatus interconnecting drive wheels with generators. Preferably gear means are provided through mechanical rotation of the vehicle wheels to drive ancillary generators for recharging current. Generator-motor units are arranged at each wheel of the vehicle. A battery system is recharged by the generator units responsive to a controller. Back-up systems to recharge the battery system such as photoelectric or solar electric panels and/or electromagnetic-induction charging levers, are included. An on-board computerized controller regulates the flow of generated current to the battery system and the flow of stored current to the motor units.

### CROSS-REFERENCE TO RELATED APPLICATION

This is a utility conversion application claiming priority based upon a prior provisional application entitled Electrically Recharged Motor Vehicle System, Serial No. 61/134,127, Filed Jul. 8, 2008.

### BACKGROUND OF THE INVENTION

I. Field of the Invention

The present invention relates generally to electrically powered motor vehicles. More particularly this invention relates to electrically powered and self-recharged vehicles, examples of which are disclosed in patents found in U. S. Class 180, Subclasses 65.1, 65.3, 242+, 214, and 216.

II. Description of the Prior Art

Electrically propelled vehicles are becoming increasingly popular in the age of scarcity and high fuel prices. Besides obviating the need for fossil fuels, electric vehicles of the so-called “zero emission” type reduce pollution by eliminating or minimizing noxious emissions. Conventional electric vehicles ultimately depend upon various types of batteries for propulsion. Diverse types of batteries are known in the art. Typical electric vehicles employ a plurality of series-connected batteries or battery modules for driving their electric motors. Numerous control circuits and recharging systems are known.

Typical electric vehicles have numerous disadvantages, primarily relating to battery limitations. Repetitive or virtually continuous battery recharging is one vexatious requirement for electric vehicles. Without periodic and substantial battery recharging, vehicle operation and battery life are severely compromised. Numerous recharging solutions are known. For example, vehicle batteries may be reenergized by recharging stations proximate the home or parking facilities of the user. Regenerative braking systems, which reverse motor and generator functions during braking to generate a recharging current from energy that would otherwise be lost, are common as well.

Other recharging approaches involve solar panels that provide an effective trickle charge, but which are insufficient for propulsion. Other ancillary and auxiliary devices that recapture energy, especially during movement, for recharging exist. Popular hybrid vehicles combine electrical engines with relatively small internal combustion motors that can recharge batteries. Some approaches use wind energy for driving turbines or generators from high velocity air as the vehicle moves.

U.S. Pat. No. 3,876,925 issued Apr. 8, 1975 discloses an electric vehicle with a wind-powered recharging system. Wind-driven vanes rotate within a housing atop the vehicle to power a generator when the vehicle is in motion, or when sufficient wind velocity is present when the vehicle is stopped. The vanes enable continuous recharging of the battery system.

U.S. Pat. No. 4,141,425 issued Feb. 27, 1979 discloses an electric vehicle including a solar panel and a wind-driven alternator for recharging batteries. A variable speed direct current motor interconnects the motor and the wheels through gearing.

U.S. Pat. No. 5,670,861 issued Sep. 23, 1997 discloses an electric vehicle with a plurality of series connected batteries. The vehicle may be recharged at a charging station, or through regenerative charging during braking. Various control modules including a traction controller are responsible for operation. Data is derived and transmitted over a serial communications bus for module operation.

U.S. Pat. No. 5,680,908 issued Oct. 28, 1997 discloses an electrically powered vehicle comprising at least one electric motor connected to a drive axle, and at least one generator connected to another axle. Batteries provide electrical energy to the motor. Transmission gearing increases the rotational speed of the generator. A control circuit selectively directs electrical power from the generator to either the motor for power or the batteries for recharge, depending upon driving conditions and requirements.

U.S. Pat. No. 5,941,328 issued Aug. 24, 1999 discloses an electric vehicle with regenerative braking. Recharging of the batteries from an auxiliary electricity source and from dynamic braking is ramped in magnitude when the batteries of charge is low.

U.S. Pat. No. 6,260,649 issued Jul. 17, 2001 discloses an electric vehicle comprising rechargeable battery cells, switches, electric circuits, control means, a drive train, and one or more motor-generators. Means are provided for switching the motor-generators between propulsion and kinetic recharging modes. The motor-generators can thus transform kinetic energy into electrical recharging energy when vehicle braking occurs during decelerate.

U.S. Pat. No. 6,659,213 issued Dec. 9, 2003 provides a control device for hybrid vehicles. A high-voltage battery powers a motor-generator power source, a low-voltage battery operates electrical loads, and an inverter controls the motor-generator. Various sensors monitoring battery condition, engine speed, vehicle speed, and accelerator demand communicate with a microprocessor to computer control operation.

U.S. Pat. No. 6,707,169 issued Mar. 16, 2004 discloses an electrical propulsion system implemented by a power generator driven by an engine.

U.S. Pat. No. 7,157,869 issued Jan. 2, 2007 discloses a control system for a vehicle having an engine for driving front wheels and a separate motor for driving the rear wheels thereof. A motor-generator driven by the engine and generates three-phase alternating-current power. An inverter converts alternating-current to direct-current for battery recharging. Various voltage levels are employed.

U.S. Pat. No. 7,208,894 issued Apr. 24, 2007 discloses an electric vehicle that uses multiple permanent magnet motor-generators and multiple batteries. Motor, torque and speed are controlled by steps, and battery connections are alternated between series and parallel modes. Acceleration, regeneration and current control are provided by delaying stepping functions. Multiple motors provide acceleration torque at low speed through series connections. During cruising, parallel connections are selected. Regenerative deceleration is provided.

U.S. Pat. No. 7,211,905 issued May 1, 2007 discloses a vehicle-mounted generator powered by either ambient wind or wind from vehicle motion. Wind streams enter a chamber housing a spiraling parabolic deck. A turbine converts wind energy to mechanical energy. An electrical generator converts the mechanical energy into electrical energy for recharging batteries or powering electric motors.

U.S. Pat. No. 7,215,034 issued May 8, 2007 discloses an electric vehicle with an A.C. generator having a rotor equipped with a permanent magnet and a field coil. The output of the A.C. generator charges the high-voltage battery. Voltage of the high-voltage battery is stepped-down by a DC/DC converter and supplied to the low-voltage battery. When the motor controller detects that the field coil has not been energized, the higher-rank controller switches so as to generate power by means of the permanent magnet of the A.C. generator and charge the low-voltage battery.

U.S. Pat. No. 7,317,295 issued Jan. 8, 2008 discloses a hybrid, four-wheel drive vehicle with an internal combustion engine, a generator for outputting DC power, an inverter for converting DC power from the generator to AC power, and an AC motor driven by the inverter for driving vehicle wheels. An electric motor controller controls the inverter, the AC electric motor, and the generator, according to torque instructions from a vehicle.

### SUMMARY OF THE INVENTION

My invention comprises an electrically powered vehicle that is recharged and self-energized. Preferably gear means are provided through mechanical rotation of the vehicle wheels to drive suitable ancillary generators for recharging current.

In essence the invention is a multi-wheeled vehicle comprising an electrical motor or motors to provide drive power to the wheels, a gear or similar mechanism to harness the kinetic energy from the wheels as they turn during the normal course of driving, a means of transmitting this harnessed kinetic energy to one or more generators for the purpose of producing electric current, and a dual battery system in which one set of batteries provides power for the use of the motors while the other battery accepts the produced current from the generators. In this fashion, as the motors deplete one battery pack while driving, the other battery pack is simultaneously recharged by the operational movement of the vehicle. Ancillary means are envisioned to provide additional current to the depleted battery in the form of a ram-air generator or generators driven by the forward motion of the vehicle, photovoltaic or solar panels situated on the vehicle as described, an emergency manual lever-driven electromagnetic induction system, and a receptacle located on the vehicle exterior to allow the vehicle to be plugged into an standard electrical outlet. It is presumed that most of the energy requirements of the, vehicle will be provided simply by vehicle operation with little or no input from these ancillary systems. The focus of the invention is to provide an electrically-driven vehicle that will recharge itself while in operation, thus making it independent of external sources of energy.

The vehicle system comprises generator-motor units arranged at each wheel of the vehicle, a battery system that will be recharged by the generator units, additional back-up systems to recharge the battery system such as photoelectric or solar electric panels and/or electromagnetic-induction charging levers, etc. An on-board computerized controller regulates the flow of generated current to the battery system and the flow of stored current to the motor units. The ultimate purpose of the invention will be a coherent electrically powered vehicle system that will recharge itself while in operation, that requires minimal inputs of energy from external sources.

Thus a basic object is to provide a self charging electric vehicle.

More particularly it is an object of my invention to provide a coherent electrically powered vehicle system that will recharge itself while in operation, that requires minimal inputs of energy from external sources.

A related object is to provide a gearing system for coupling recharging generators to the wheels of the vehicle.

Another important object is to recharge the batteries in an electric vehicle with excess energy tapped from the wheels.

It is also an object of my invention to provide an electric powered vehicle which moderates the limited range problems associated with prior art electric vehicles.

Another an object is to provide an electric powered vehicle that utilizes a mechanical gear connection that taps vehicle wheel movement at appropriate speeds to generate electricity for recharging batteries.

Another object is to reduce the need for battery-powered vehicles to stop periodically to recharge from independent electric sources. This is a time-consuming inconvenience and an additional expense to the operation of the vehicle. Also, at this time no infrastructure similar to fuelling stations for conventional vehicles exists for the use of electric vehicles to recharge.

Another object is to increase the range between recharging dictated by present battery technology for battery-powered electric vehicles.

Yet another object is to provide a system of the character described that is compatible with hybrid technology that combines electric power for low speed driving but requires a gasoline engine for higher speeds.

Other basic objects are to provide a system that uses electric power only, produces no emissions, requires no additional power source, and combines available, proven technologies into a self-sustaining recharging electrical system.

Yet another object of my invention to provide an electric powered vehicle which substantially improves the typical driving range characteristic of conventional electric vehicles.

Another object to provide an electric powered vehicle which utilizes a set of separate generators and a pair of separate battery banks that function independently for propulsion, with means alternating the source of recharging.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a pictorial top view of a preferred form of the invention;

FIG. 2 is a diagrammatic view of the preferred generator and recharging system;

FIG. 3 is a side elevational view of the an electric vehicle constructed in accordance with the invention;

FIG. 4 is a top view of the an electric vehicle constructed in accordance with the invention;

FIG. 5 is a diagrammatic view of a lever-operated recharging system;

FIG. 6 is block diagram showing the basic method of recharging employed in the best mode;

FIG. 7 is a diagrammatic view of the intermeshing gear system preferably used with the invention; and,

FIG. 8 is a diagrammatic view of the invention applied to a standard electric golf cart chassis for the purpose of testing.

### DETAILED DESCRIPTION OF THE DRAWINGS

In reference to the various drawings, the preferred embodiment of the invention comprises a vehicle chassis and related systems distributed thereon that will, once combined, overcome the drawbacks inherent with present electric or hybrid technology vehicles.

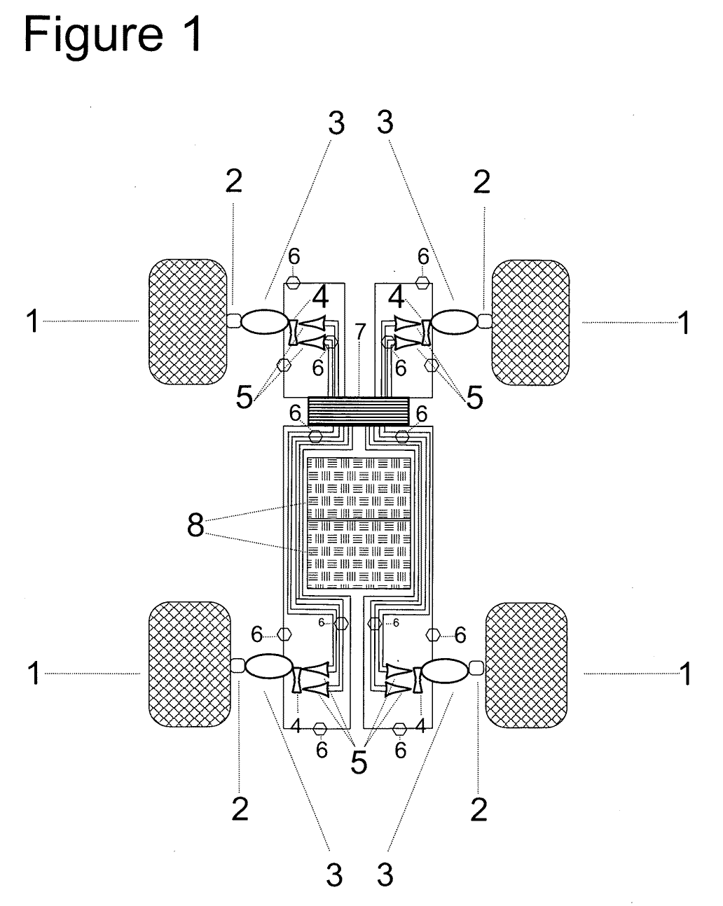

A first embodiment is shown in FIGS. 1-5 of the appended drawings. FIG. 1 shows an electric vehicle utilizing four wheels 1, although embodiments for heavier duty may require six or more wheels. Each of the four wheels 1 are driven by an associated driveshaft 2. Each driveshaft 2 is driven by an electric motor 3 attached directly thereto. Each driveshaft 2 extends through the center of its electric motor 3 and terminates at a gear system 4.

Thus, the mechanical energy of the rotation of each driveshaft 2 will be transferred directly from the driveshaft 2 into the first gear of the gear system 4.

A mechanical advantage is obtained by the gear system 4. The gears 4 drive generator 5 at several times the RPM of the electric motor 3. Mechanical energy is transferred through the various gears of the gear system 4 to the generators 5 which are used for recharging. An increased RPM speed results at the generators 5 attached to the final gear of the gear system 4.

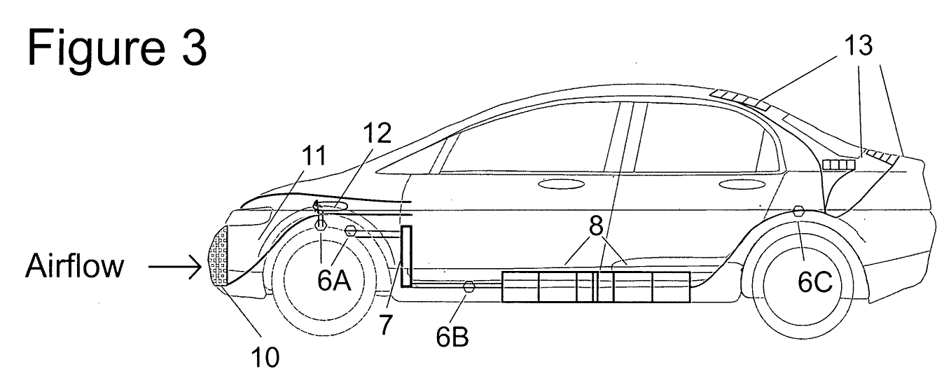

Recharge electricity produced by the generators 5 in response to gears 4 is relayed by a conduction wiring system 6 (FIGS. 1, 3) to a controller unit 7, which will in turn regulate the flow of the produced electric current to battery systems 8. The battery systems 8 comprise at least two separate battery packs which are to be independently charged and discharged as described below. This recharge connection insures that the battery systems 8 will be continuously charged, but overcharging by the produced electric current is prevented. A similar conduction system 6 of wiring will facilitate the flow of stored current between the battery system 8 and the controller unit 7. In addition, a separate conduction system 6C of wiring will allow the controller unit 7 to regulate the flow of stored electric current from the battery systems 8 to the motor units 3 in such a manner as to provide sufficient current to the various motor units 3 for their relative torque requirements while preventing wastage or overload to the various motor units 3.

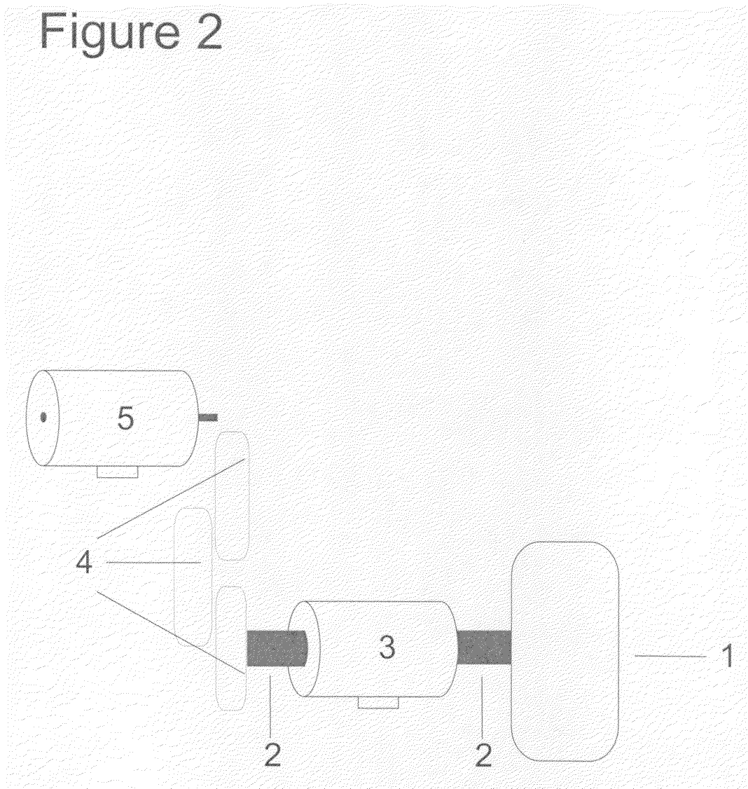

FIG. 2 shows more detail of a typical wheel 1, driveshaft 2, motor 3, gear system 4, and generator 5. Since each wheel is the same, only the right front wheel is discussed. Mechanical energy from rotation of wheel 1 is transferred through the center of the motor 3 by the driveshaft 2. This mechanical energy is applied to the first gear of the gear system 4. This is transferred through the chain of gears 4 to the rotors of the generators 5. The mechanical advantage provided by the gear system 4 increases revolutions of the generators 5 with each single revolution of the wheels 1. It is contemplated that in the best mode the gear advantage will be between 3:1 and 12:1. As a result, sufficient electric current will be produced by the generators 5 to allow for the electrical demands of the vehicle systems.

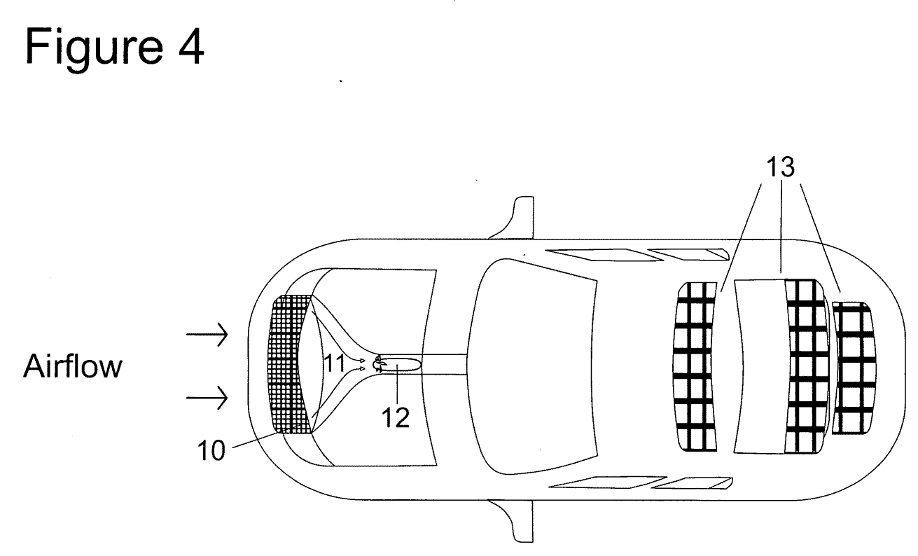

FIGS. 3 and 4 show the air intake grills 10 for the airflow ductwork 11 that will provide airflow for the ram-air generator 12 located within the vehicle. The ram-air generator 12 is provided as an additional means for charging the battery system 8 and will transmit the produced electric current by means of conduction system 6B of wiring connected to the controller unit 7. This figure also shows potential locations for the photoelectric or solar electric panel system 13, which will provide an additional source of electric current to the controller unit 7 by a similar conduction system 6C of wiring for recharging the battery system 8.

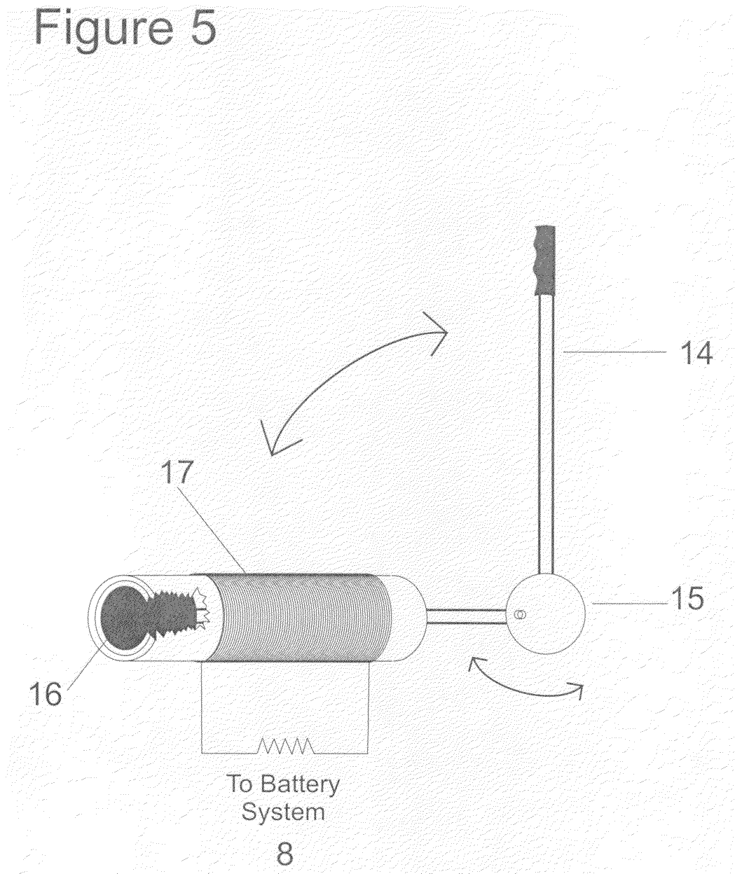

FIG. 5 shows a preferred emergency electromagnetic induction system that will provide an additional source of electric current for recharging the battery system 8 of the vehicle. The preferred system includes a charging lever 14 that will, when hand-actuated back and forth, moves a pulley 15 attached to a permanent magnet 16 located within a wire coil 17 such that electromagnetic induction occurs. This system is intended as an emergency method for providing a minimal charge directly to the battery system 8 in order to position the vehicle for motion and obtain motion. The lever system is intended for use in the event that the battery system has been completely depleted and the photoelectric or solar panels cannot be employed. Lever 14 in the vehicle cabin, similar to the parking brake lever typically found in most vehicles, will be connected to an electromagnetic induction system. When lever 14 is manually actuated, the electromagnetic induction system will provide enough energy to temporarily charge the battery system in order to position the vehicle for motion. Once in motion, each generator system will begin producing electricity to recharge the battery system and thus drive the vehicle.

Preferably, a plug or port is provided on the exterior of the vehicle to facilitate the emergency use of an independent power source, such as an automotive battery or standard electric outlet, to recharge the battery system.

Thus each wheel 1 of the vehicle drives a shaft connected directly to electrical generators via a set of gears designed to gain a mechanical advantage for each revolution of the wheel. The gear system 4 connects to the generators by intermeshing gears, chain drive, or belt drive. Given the torque loads involved, the preferred embodiment of the invention will use intermeshing gears to gain this mechanical advantage. The motion of the wheels will mechanically drive the corresponding shaft, which will engage the gear system and thus turn the internal components of the generators several times for each wheel revolution. The effect will be the production of electric current by each generator unit. As the wheel turns faster and faster, it will greatly increase the revolutions within the generators, producing an ever-increasing amount of electric current. This produced electricity will be transmitted to a controller unit, which will regulate the flow of this current to the vehicle battery system to prevent overcharging. This stored energy will then be transferred from the battery system by the controller unit to power electric motors attached to each wheel system for direct drive of each wheel. Additionally, the stored current will be allocated by the controller unit to other electrical components of the vehicle, such as the heating/air conditioning system, window motors, electronic door locks, vehicle control panel instruments & lighting, etc.

Faster drive speeds and acceleration will require greater amounts of stored energy from the battery system, but will also generate greater amounts of current from the generator units due to the increasing revolutions of the wheels. Slow speed driving and cruising speeds will require less exertion from the electric motor, which will require less electric current from the generators to recharge the battery system. Since the revolutions of the generators will be fewer during low speed driving, they will be producing less electricity concurrent with the reduced mechanical torque needed for the motor to drive the wheel. As a result, a harmony will be achieved between the components of the system. As the relative drive speed for the wheel increases or decreases, so will the electric current being produced by the revolution of the generators and the amount of current required by the motors to meet the demands of the drive system.

Relatively smaller motors and generators can be utilized since they will be required to drive only one wheel of the vehicle rather than provide power to move the entire vehicle. Since they will be connected to each individual wheel, very little mechanical energy will be lost compared to vehicles that utilize a transmission or differential system to divide engine power between two or more wheels. Second, this design will distribute the weight of the various vehicle operating systems equally throughout the vehicle chassis.

Third, the preferred design will provide a redundant source of drive power for the vehicle. In the event that one or more of the motors or generators fails, the other components of the system will still operate to drive the unaffected assemblies of the vehicle.

Each generator located in each wheel assembly will charge an on-board battery system. The electricity produced by the generators will be stored in this battery system for the use of the motor units to achieve the required drive torque. As soon as vehicle motion is achieved by driving a given wheel or wheels, unpowered wheel assemblies begin producing electricity for recharging the battery system. This battery system will also store energy for the operation of other vehicle systems, such as vehicle lighting, window motors, door locks, etc. Present battery technology is sufficient to provide for these energy requirements and to store sufficient energy for extended periods of time. The vehicle control panel will include an indicator to indicate the charged status of the battery system, not unlike the fuel gauge in a vehicle with an internal combustion engine and fuel tank.

In addition to the generators in each wheel assembly, the vehicle will have additional methods for recharging the on-board battery system. In the event that the vehicle has been motionless for a prolonged period of time, the battery system may not retain enough energy to position the vehicle in a manner to obtain motion or operate the other vehicle electrical systems. In this event, photoelectric or solar electric panels 13 mounted on the exterior roof, trunk lid, and/or on top of interior surfaces recharge the battery system enough to maintain a minimal charge to the battery system. Additionally, the wind-driven ram air generator system 12 behind the vehicle front grill and will be driven via ductwork by the airflow created by the forward motion of the vehicle.

The present infrastructure of servicing dealers will be able to service and repair this vehicle with a minimum of additional training. In fact, this vehicle should require less servicing over the life of the vehicle than a typical internal combustion engine system since it will have far fewer moving parts and operating systems. The vehicle will be lighter than a comparable vehicle with an internal combustion engine or hybrid technology since it will dispense with the engine, transmission, emissions system, engine cooling system, and fuel tank.

With the use of synthetic lubricants, this vehicle will greatly reduce dependence on oil-based products such as gasoline and lubricating oil. Additionally, since the vehicle will not produce any emissions, it will be very environmentally friendly.

Using an existing production vehicle as a basis, these technologies could easily be incorporated in a relatively short period of time. This would facilitate the prototype and subsequent production processes. This vehicle would retain most of the features and functions of a standard production vehicle. The suspension, braking, lighting, steering, heating & air conditioning, etc. would remain essentially the same as the existing production vehicle. Some minor modifications would be needed to incorporate the electric-drive wheel assemblies to each wheel and to provide for the on-board battery system, electronic control system, photoelectric or solar electric panels, emergency electromagnetic induction charging system, etc. These systems will require less room and will impose less weight on the vehicle chassis than the combined internal combustion engine systems being eliminated.

### Operation

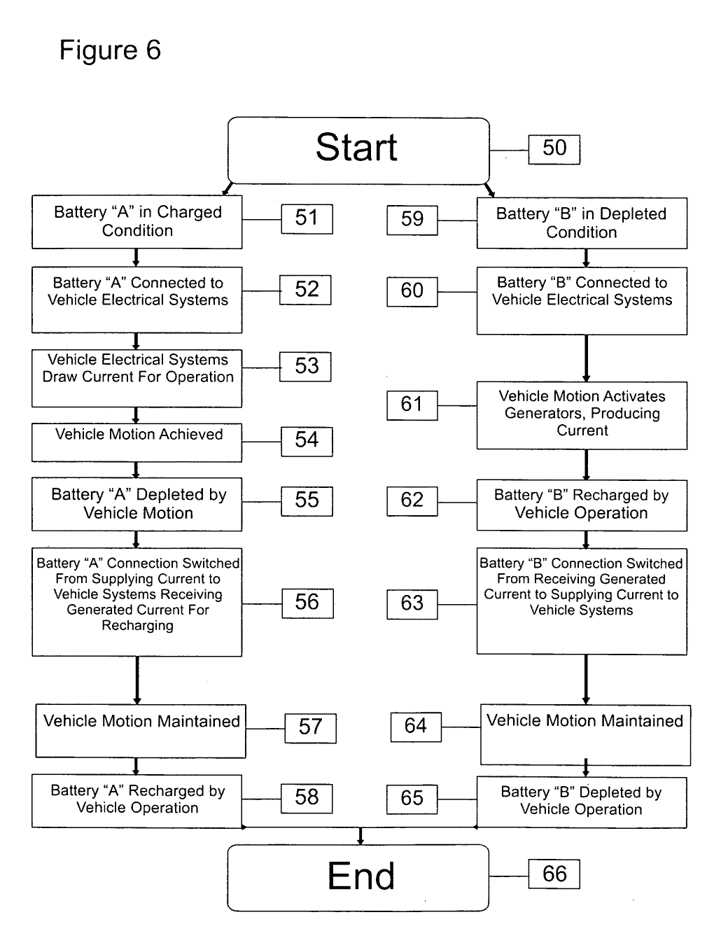

Referring now to FIG. 6, the operation sequence 50 begins with electric actuation of the system through a “start” function 51 enabled by an internal switch. A first battery system 51 (i.e., part of battery packs 8) will be fully charged at the start. In step 52 the first battery system is connected to the controller and from thence to the drive motors for propulsion in step 53 producing motion is step 54. As motion occurs the first battery system depletes slowly as indicated at 55. In step 56 the first battery, now depleted as sensed by the system is switched from the drive mode to the recharge node. Vehicle motion is maintained by other drive wheels with other batteries as indicated at 57 and motion is maintained as indicated by box 58.

During steps 52, 53 a second battery, “B” may be in a depleted condition as indicated by box 59. This battery is connected to the recharging system as in step 60, and vehicle motion turns the generators in step 61 to recharge battery “B” as indicated by step 62. When appropriately charged, the connection to battery “B” is reversed, being switched from a charging mode to a drive mode as in step 63. Propulsion is maintained as in step 64, and battery “B” becomes depleted as in step 65. When the vehicle is parked, END step 66 occurs as the system is turned off.

### Prototypes & Testing

Two prototypes incorporating the teachings of this invention are detailed. These consist of an intermeshing gear mechanism intended to represent the gear system 4 described in the preferred embodiment of the invention, and a chassis comprising standard electric golf cart modified with a second battery system, battery charge status monitors, a belt-driven electric generator, charge controllers, and mock-ups of the solar panel and ram air turbine systems to represent a total vehicle system as described in the preferred embodiment of the invention.

The gear mechanism consists of a series of intermeshing gears tied directly to a small electric motor. The motor is secured to the base of the gear system and is controlled by an electronic speed controller. This system works with 120 VAC derived from a battery and inverter. The gears are handed to provide a 10:1 gear ratio from the driven gear to the small gears attaching this system to a series of electric generators arrayed along the top of the mechanism. The controller unit allows the user to vary the input of current to the motor and allows for directional operation of the motor. It also employs a circuit-breaker to avoid an overload to the motor. These systems are very similar to those employed in the preferred embodiment of the invention as described. The generators were chosen to provide 12 to 16 VDC at the average operating speed of the motor. These generators are wired together into a male 12 VDC adapter to provide connection to a battery system for recharging.

The first test consisted of running the system at forty percent of the top speed of the motor, since this is the assumed average speed required to power a passenger vehicle. This speed also yielded a consistent 15.3 VDC to be used for recharging the depleted battery. In this test, three generators were utilized to increase the amps provided to recharge the depleted battery. At this constant speed, it took an elapsed time of six hours and forty-one minutes to discharge the charged battery to a level of five percent of its capacity. By comparison, the depleted battery was recharged to one hundred percent of its capacity within an elapsed time of four hours and twenty-eight minutes.

The second test retained the operating system of the first, but varied the input speed from zero to seventy-five percent of the top speed of the motor. Great care had to be taken to prevent an overload from faulting the circuit breaker on the controller unit, which occurred regularly at eighty percent or more of the top speed of the motor. This test was designed to simulate driving conditions with starting, acceleration, deceleration, and stopping speeds employed. Under these circumstances, varying amounts of current were being produced by the generators in relation to the drive-speed of the motor. At slower speeds, insufficient current was produced to allow recharging of the depleted battery. At higher speeds, the amount of current produced was controlled to an acceptable level by use of regulator/converter that maintained the generated current at 15 VDC for use in recharging the depleted battery. This test yielded an elapsed time of five hours and seventeen minutes to deplete the charged battery to within five percent of its capacity while requiring an elapsed time of four hours and fifty-nine minutes to recharge the depleted battery to one hundred percent of its capacity.

A standard 48 VDC golf cart was chosen as the vehicle test-bed. This choice was based on the fact that a standard electric golf cart already employs many of the vehicle systems as described in the preferred embodiment of the invention. The steering, braking, electronic speed control, and battery systems are generally similar to those envisioned for the passenger vehicle. Using this chassis as a basis, several modifications were made to install the additional systems unique to the invention. First, an additional bank of batteries was installed with the appropriate wiring to allow either battery pack to power the drive system of the vehicle. Second, battery status monitors were installed on each battery pack to track the relative charged conditions of the two battery systems. Third, one of the rear quarter panels was removed to allow access to the vehicle frame and rear drive wheel of the vehicle. An additional, smaller diameter wheel was installed along the vehicle frame directly above the existing drive wheel in such a fashion to be in direct contact with the drive wheel. This smaller wheel thus derives some of the kinetic or mechanical energy from the drive wheel revolutions to be transmitted, via a belt system, to a generator. This generator was also attached directly to the frame of the vehicle in a fashion that will allow the proper distance from the drive wheel to maintain tension for the belt system. The relative diameters of the pulleys were calculated to produce a 3:1 gear ratio between the drive wheel revolutions and the generator pulley. This ratio was desired because it was calculated to produce the required amount of current for recharging the battery system at the average drive speed of the vehicle. In addition, a charge controller was installed to prevent an overload to the battery pack that was being recharged by the operation of the vehicle. Technically a “dump-load” controller, this safeguard prevents a surge of current to the battery system when the vehicle speed increases quickly or when the current produced by the generator exceeds the voltage of the battery system by more than fifteen percent.

Additional systems described in the preferred embodiment of the invention were also installed on this vehicle. A 10-watt solar panel was installed on the vehicle roof, as was a mockup of the ram-air turbine generator envisioned for the vehicle. The latter consists of a scoop to channel incoming air from the forward motion of the vehicle into a tube of decreasing diameter. Within the tube is located a generator driven by a propeller. Forward motion of the vehicle directs a volume of air into this system. This volume is slightly compressed by the decreasing diameter of the tube, creating a Venturi Effect. This increases the speed of the airflow passing by the generator and thus the amount of current produced relative to the actual forward speed of the vehicle. The solar panel and wind turbine are wired to the system providing produced current to the depleted battery pack via a charge controller. The solar panel will produce a constant trickle charge load to top off the battery, provided that sufficient sunlight is available to activate the panel.

The vehicle system was initially bench-tested at a constant speed and voltage in order to determine the relationship between the elapsed time needed to deplete the charged battery-versus the elapsed time required for the generated current to recharge the battery system. The top speed of the vehicle was determined to be twenty-two miles per hour. Given this relatively low speed, the optimum voltage created to recharge the battery pack was created at an average speed of 16.3 miles per hour, or seventy-four percent of the top speed. The vehicle was tested under these conditions beginning with the charged battery at one hundred percent of its capacity and the depleted battery at ten percent of its capacity. At this constant speed and voltage, it took an elapsed time of thirteen hours and ten minutes to deplete the charged battery to within ten percent of its capacity. Concurrently, it took an elapsed time of twelve hours and twenty-six minutes to recharge the depleted battery to one hundred percent of its capacity.

The second bench test proceeded with the same battery charge levels as the first, but was intended to replicate actual driving speeds and conditions for the operation of the vehicle. The speed was varied between zero miles per hour and the top speed of the vehicle. As anticipated, insufficient current for recharging was produced at the slower operating speeds while the higher-end operating speeds produced more current than was desired, making the use of the dump-load controller necessary. Varying the speeds to replicate starting, stopping, acceleration, deceleration, and cruising speeds resulted in an elapsed time of twelve hours and forty-six minutes to deplete the charged battery to within ten percent of its capacity. Concurrently, an elapsed time of twelve hours and twenty-five minutes was required to recharge the depleted battery to one hundred percent of its capacity.

The final test with the vehicle consisted of a road test starting at the same battery charge levels as the others. The charged battery began at one hundred percent of its capacity and the depleted battery at ten percent. This test was designed to gather data under actual driving conditions. An elapsed time of ten hours and fifty-four minutes was needed to deplete the charged battery, while an elapsed time of ten hours and ten minutes was needed to recharge the depleted battery to one hundred percent of its capacity.

### Conclusions:

The most difficult problem was the widely varying voltage produced by the operation of the vehicle. In the prototypes, this was handled simply by means of allowing the battery to regulate the voltage in cooperation with an overload controller. In other words, at the lower operating speeds of the vehicle, insufficient voltage was being produced to recharge the depleted battery system. Likewise, at the higher range of the operating speeds of the vehicle, an overabundance of current was being produced, necessitating the use of a controller to prevent an overload to the battery system. This problem is inherent given the fixed gear ratio for both the gear system and the belt-driven system employed in the prototypes. The most obvious solution would be to calculate the required rpm's for the generators to produce the optimum voltage for recharging of the battery system. This occurred in the initial static tests for each prototype, in which the optimum voltage was calculated and generators were selected which would produce this optimum voltage at the prescribed average operating speeds of either the gear system or the vehicle. In the preferred embodiment of the invention, it is proposed that a three-geared transmission system be used to transmit the mechanical energy derived from the drive wheels to the generators. At slow operating speeds, a small diameter gear will be employed to increase the gear ratio and thus the revolutions of the generators relative to the drive wheel revolutions to maintain the optimum voltage being produced. As the operating speed of the vehicle increases and the produced voltage exceeds the optimal voltage for recharging, a larger diameter gear will deploy to decrease the revolutions of the generators in relation to the drive wheels. Finally, as the vehicle operating speed nears the higher end of its driving spectrum, an even larger diameter gear will deploy to maintain the average revolutions of the generators within the prescribed range. The result will be to maintain the revolutions of the generators within those required for the production of the optimum voltage for use in recharging the depleted battery and preventing an overload to the battery system. For example, at lower operating speeds (0 to 20 MPH) a small diameter gear will be used to increase the gear ratio to an average of 10:1 versus the wheel revolutions. As vehicle operating speeds increase into the mid-range (25 to 45 MPH), a larger diameter gear will deploy to reduce the gear ratio of the generators to 3:1 versus the revolutions of the drive wheels. This will keep the voltage being produced within the optimal range to produce the desired voltage for recharging. As the operating speed increases into the higher range (50 to 75 MPH), an even larger diameter gear will deploy to confer a 1:1 gear ratio relative to the generators and drive wheel revolutions. The result will be to maintain the revolutions of the generators within a prescribed range in order to produce the desired voltage to be utilized in recharging the battery system, while preventing an overload to the batteries.

Tested Hardware:

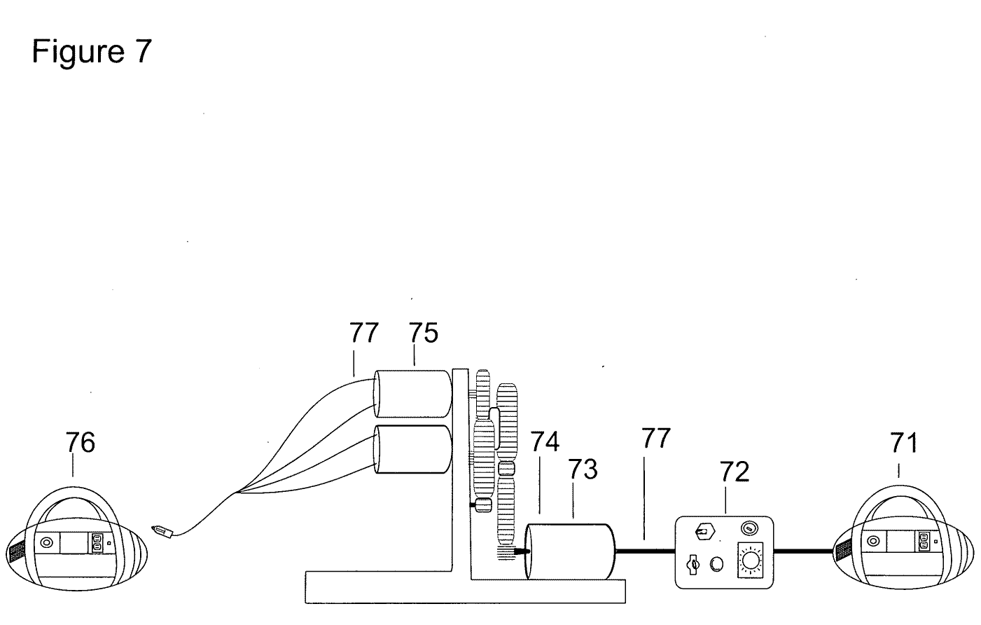

FIG. 7 represents the intermeshing gear system to be used in the preferred embodiment of the invention. The prototype consists of an initial battery/inverter 71, an electronic speed controller 72, an electric motor 73, the intermeshing gear system 74, electric generators 75, and a secondary battery/inverter 76. These are interconnected by a series of wiring 77.

Initially the battery/inverter 71 is fully charged and supplies 120 VAC via the wiring 77 to the electronic speed controller 72 The speed controller 72 regulates the amount of current supplied via wiring 77 to the electric motor 73. The electric motor 73 has a driveshaft and small gear connected to engage the intermeshing gear system 74. Gear system 74 is provides a 10: 1 gear ratio from the gear connected to the electric motor 73 to the gears connected to the electric generators 75 arrayed about the top of the gear system 74.

Electric generators 75 are connected via wiring 77B to a secondary battery/inverter 76, which is depleted to ten percent of its rated capacity. Once initiated and running at the proper range of speed, the electric motor 73 propels the intermeshing gear system 74 to produce an electric current from the electric generators 75. DC current is transmitted via the wiring 77 to the secondary battery/inverter 76 for the purpose of recharging this secondary battery/inverter 76 while the entire system is in operation. Concurrently, the initial battery/inverter is depleted while operating the entire system.

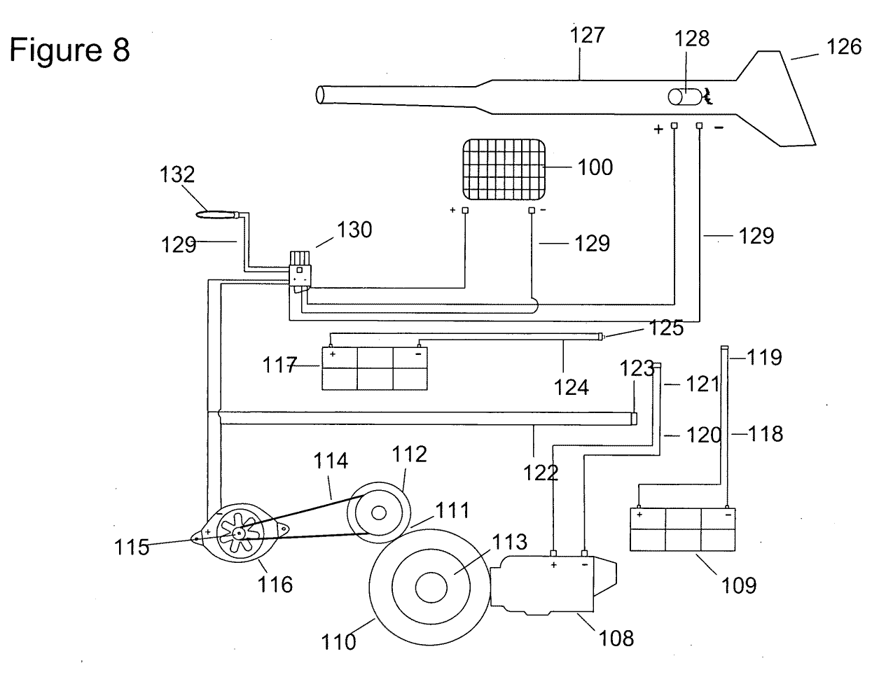

FIG. 8 represents a vehicle system 100 derived from a standard electric golf cart modified as discussed below. Apparatus comprises equipment originally installed on the golf cart; a conventional electronic speed controller 108, an initial battery system 109, and the right rear driving wheel 110. None of these components have been altered from their original configuration with the exception of the modified wiring that interconnects them with the added components unique to the invention. These added components are a small wheel 112 connected to the vehicle frame in such a fashion that by means of gravity and friction a contact point 111 is created between the small wheel 112 and the right rear driving wheel 110 for transmitting energy derived from the right rear drive wheel 110 to the small wheel 112. Wheel 112 drives pulley 113 attached to the face of the wheel hub which engages a drive belt 114 entrained upon a smaller pulley 115, which in turn drives permanent magnet alternator 116.

A second battery system 117 has been added to the golf cart. Battery system 117 is identical to the initial battery system 109 originally installed on the golf cart. The initial battery system 109 has been altered from its original configuration by the inclusion of a longer system of wiring 118 terminating in a three-prong male adapter 119. Likewise, the electric drive motor and electronic speed controller 108 have also been modified by the addition of lengthened wiring 120 terminating in a three-prong female receptacle 121. Similar wiring 122 also emanates from the permanent magnet alternator 116 and terminates in a three prong female receptacle 123. Wiring 124 leads from the second battery system 117 and terminates in a three-prong male adapter 125. The wiring system is designed such that the male adapter from each battery system can interconnect with the female adapter from either the electric drive motor or the permanent magnet alternator. For example, the three-prong male adapter 119 from the initial battery system 109 can connect with the three-prong female receptacle 121 attached to the electric drive motor and electronic speed controller 108 to provide power from the initial battery system 109 to drive the vehicle. Alternatively, this same three-prong male adapter 119 can also be connected to the three-prong female receptacle 123 coming from the permanent magnet alternator 116 to receive the electric current produced by alternator 116 for recharging the initial battery system 109. The same scenarios are true for the three prong male adapter 125 connected to the second battery system 117, in that it can be utilized to connect with either female receptacle as needed.

In practice, the second battery system 117 was fully charged and connected to the electric drive motor and electronic speed controller 108 to power the vehicle. The electric drive motor and electronic speed controller 108 were employed to drive the right rear driving wheel 110 of the vehicle. Rotation of driving wheel 110 rotates small wheel 111 to impart the kinetic energy via pulley 113, drive belt 114, and smaller pulley 115 to rotate the inner workings of the permanent magnet alternator 116 to produce electric current. Current transmitted via wiring to the initial battery system 109, which began the test in a depleted state, effectuates recharging.

Thus, the operation of the vehicle systems combined to deplete the second battery system 117 while simultaneously recharging the initial battery system 109. At the conclusion of testing, the second battery system 117 was depleted and the initial battery system 109 was recharged. The two male adapters were then be swapped to the opposite female receptacles with the result that the recharged initial battery system 109 could power the electric motor and electronic speed controller 108 to operate the vehicle while the depleted second battery system 117 could receive the current produced by the permanent magnet alternator 116 during the operation of the vehicle.

An air collection scoop 126 is directed to capture the airflow created by the forward motion of the vehicle. Scoop 126 funnels the airflow into a series of tubing 127 of descending diameter. Contained within the series of tubing 127 is a wind-driven generator 128. The effect of the forward motion of the vehicle is to force air into the air collection scoop 126, where it is slightly compressed by the descending diameter of the series of tubing 127. This slight compression leads to an increased airflow bypassing the wind-driven generator 128, thus turning driven generator 128 to produce electric current. This wind-driven generator 128 is connected via wiring 129 to a voltage controller 130 to regulate the input of current into the battery recharging system of the vehicle.

Similarly, a solar electric panel 131 is attached to the vehicle roof and is connected via wiring 129 to the voltage controller 130. Controller 130 prevents an overload to the various battery systems of the vehicle by diverting overloads via wiring 129 to a heating element 132.

If the voltage entering the battery recharging system exceeds a specifically set amount, the overload is dumped to the heating element 132 to dissipate the unneeded voltage.

The wind-driven generator 128 contributes additional amps to the recharging process to decrease the elapsed time needed to recharge the depleted battery system. The solar electric panel 131 is designed to maintain a constant float charge to the recharging process in order to top off the battery system being recharged.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. An electric vehicle that recharges itself during operation, the vehicle comprising:
a chassis;
a plurality of drive wheels associated with the chassis;
an electric motor or plurality of motors, at least one motor driving at least one wheel;
a plurality of generators for generating recharge current, at least one for each motor;
a gearing means for driving the generators at an RPM speed greater than the RPM speed of the drive wheels;
a first battery system for driving the vehicle until said first battery system is discharged;
a second battery system for driving the vehicle when the first battery system is discharged;
a means for recharging the second battery system by at least one of said generators while the first battery system is driving the vehicle; and,
a means for recharging the first battery system by at least one of said generators while the second battery system is driving the vehicle.

2. The electric vehicle as defined in claim 1 further comprising back-up means for recharging the battery systems independently of said drive wheels.

3. The electric vehicle as defined in claim 2 wherein said back-up means comprises photovoltaic or solar panels.

4. The electric vehicle as defined in claim 2 wherein said back-up means comprises a manual, lever-driven electromagnetic-induction system.

5. The electric vehicle as defined in claim 2 wherein said back-up systems comprises a ram-air wind driven generator.

6. An electric vehicle that recharges itself during operation, the vehicle comprising:
a chassis;
a plurality of wheels associated with the chassis;
at least one electric motor for driving at least one wheel;
at least one electric generator for generating recharge current;
a gearing means interconnecting the motor with the generator for driving said at least one generator at an RPM speed greater than the RPM speed of the driving wheels;
a first battery system for driving the vehicle until the first battery system is discharged;
a second battery system for driving the vehicle when the first battery system is discharged;
a means for recharging the second battery system by said at least one generators while the first battery system is driving the vehicle;
a means for recharging the first battery system by said at least one generators while the second battery system is driving the vehicle; and,
back-up means for recharging the first and second battery systems independently of said motors or drive wheels.

7. The electric vehicle as defined in claim 6 wherein said back-up means comprises photovoltaic or solar panels.

8. The electric vehicle as defined in claim 6 wherein said back-up means comprises a manual, lever-driven electromagnetic-induction system.

9. The electric vehicle as defined in claim 6 wherein said back-up systems comprises a ram-air wind driven generator.
